(19) United States
(12) Patent Application Publication
(10) Pub. No.: US 2026/0069072 A1
(43) Pub. Date: Mar. 12, 2026

(54) MODULAR CONTAINER STACK AND METHOD FOR STACKING A MODULAR CONTAINER STACK

(71) Applicant: Belter B.V., Amsterdam (NL)

(72) Inventor: Rick Steven VOOGT, Amsterdam (NL)

(73) Assignee: Belter B.V., Amsterdam (NL)

(21) Appl. No.: 19/150,569

(22) PCT Filed: Jan. 25, 2024
(86) PCT No.: PCT/NL2024/050032

§ 371 Date: Jul. 24, 2025

(30) Foreign Application Priority Data
Jan. 26, 2023 (NL) 2034026

(51) Int. Cl. A47G 29/14; B65D 21/02

(52) U.S. Cl. CPC A47G 29/141; B65D 21/0209; A47G 2029/144

(57) ABSTRACT

A modular container stack (10) comprising one or more stackable containers (100). The stackable containers are adjacently packed in one or more lateral planes (101) and stacked along a longitudinal direction (102) for forming a stack. Each stackable container (100) provides an internal storage space for storing a respective object. Each internal storage space is adapted to substantially match dimensions of the respective object. Each stackable container (100) comprises a door (120) on an exterior side of the stack facing a lateral direction, and a locking device (130) for locking the door (120). A fixation mechanism (200) is arranged for fixating the stackable containers (100) with respect to each other. The fixation mechanism (200) comprises a first mount (210) and a second mount (220) at an adjustable distance (D) from the first mount (210). Opposing ends of the stack facing the longitudinal direction are mounted between the first and second mount (210, 220).

The invention relates to a modular container stack and a method for stacking a modular container stack.

Parcel delivery today is mostly provided by carriers in three ways: via door-to-door delivery, via delivery to manned Pick Up Drop Off Points (PUDO's) e.g. located in retailer outlets, or via unmanned PUDO's such as parcel lockers.

Door-to-door delivery is performed by individual parcel deliverers, e.g. traveling between recipient addresses by van, by e-bike or by foot, and requires an exact hand-over time and place between the deliverer and recipient. If either the deliverer or the recipient fails to meet the hand-over time and place, the parcel delivery may not be able to take place. Also, each carrier provides its own door-to-door delivery service with different routes and stops, and the available hand-over times offered by different carriers may vary. Hence, door-to-door delivery is not designed to be “carrier agnostic”, or compatible with different carriers.

PUDO's have as a benefit that they don't require an exact hand-over time, however they still require the parcels to be delivered to a PUDO by each single carrier, and often are not ideally located. Carriers may license their manned PUDO service to a retail store, e.g. within a shopping centre. However, to deliver and pick up parcels, both the carriers as well as the parcel recipients should be able to travel to the retail store inside office hours.

Unmanned PUDO's, or parcel lockers, may e.g. be located at the outer boundaries of living areas or outside of the same retail outlet clusters, and are more often independent of office hours. However, upon delivery or pickup, each individual parcel is to be manually stored in or removed from a respective locker, and the parcel delivery management system is to be updated correspondingly, which may be time consuming for the carrier. Moreover, unmanned PUDO's may be provided with a standard range of locker sizes, which makes them unsuitable or over dimensioned for a majority of parcels. Also, the recipient may still need to travel significantly to pick up or return the parcel.

It is an object of the present invention to at least address the abovementioned issues by providing a customizable and transportable unmanned parcel locker.

### SUMMARY

In summary, the invention pertains to a modular container stack comprising one or more stackable parcel containers. The one or more stackable parcel containers are adjacently packed in one or more lateral planes and stacked along a longitudinal direction for forming a stack. Each stackable parcel container provides an internal storage space arranged for storing a respective parcel of corresponding dimensions. Each stackable parcel container comprises a door on an exterior side of the stack facing a lateral direction for allowing access to the respective internal storage space, and a locking device for locking the door.

The modular container stack comprises a fixation mechanism, arranged for fixating the one or more stackable parcel containers with respect to each other. The fixation mechanism comprises a first mount and a second mount at an adjustable distance from the first mount. Opposing ends of the stack facing the longitudinal direction are mounted between the first and second mount.

Accordingly, one or more objects, such as parcels or other items, can be efficiently stored into corresponding storage spaces of respective stackable parcel containers, which are assembled, packed and stacked, into the modular container stack as described. By adjacently packing the stackable containers in one or more lateral planes, and stacking them along the longitudinal direction, a compact and manageable stack is provided, which can be transported and positioned at strategic locations as a unit, e.g. by a delivery van or a truck, for example to provide an unmanned PUDO. Since the door on each stackable parcel container provides access to the respective internal storage space from a lateral exterior side of the stack, each parcel can be taken out of its parcel container without having to disassemble the stack. As a result, the modular container stack may be ready for use after being placed at a strategic location.

Such locations e.g. include pavements and parking lots alongside streets and highways, at or near public transport hubs, in parks and recreational zones, on business or university campuses, and in other areas in the public domain. The location can for example be calculated based on geographic clustering of recipient addresses, to minimalize the travel distance between each recipient address and the location of the unmanned PUDO. The one or more objects, e.g. parcels, may be selected based on the calculated geographic clustering, to adapt the size of the modular container stack to the number of recipients addresses in the geographic cluster, thereby optimizing the efficiency of delivering parcels for the carrier as well. For example, after calculating one or more geographic clusters based on a plurality, or distribution, of parcel recipient addresses, the optimal location of an unmanned PUDO can be defined inside each geographic cluster. Next, for each unmanned PUDO, a selection of parcels can be made that corresponds with the recipient addresses of the respective geographic cluster. The number of stackable parcel containers in a stack may correspond with the number of parcels to be delivered within a respective geographic cluster, to optimize the size of the stack.

For example, the modular container stack can be transported from a truck to its location by means of a hand truck. Alternatively, the modular container stack may be provided with wheels for transporting it to its location.

Each recipient can e.g. receive a message that his or her parcel is delivered in the stack and at which location within the given geographic cluster, or travel distance, the stack was dropped. The recipient may be able to open the locking device of a respective stackable parcel container by means of a key, code or an e-token, e.g. received on a mobile device.

For example, each stackable parcel container may comprise a communication system, for providing a signal connection e.g. based on a WiFi, NFC or BlueTooth protocol, between the stackable parcel container and a user device. In this way, the user can e.g. book a specific parcel container, the parcel container can e.g. allow access to the internal storage space in a certain time slot, an e-token can e.g. be transmitted to the locking device to open the respective parcel container, and multiple parcel containers can e.g. provide a status update of the modular container stack, such as the number of parcel containers that are available for return or first shipments.

Optionally, users can (pre) book one or more stackable parcel containers in the modular container stack for the return or first shipment of one or more parcels or other items. For example, a user may register online, or via the user device, that a parcel is to be returned to sender on a specific date, and a modular container stack comprising an empty parcel container for storing the respective parcel to be returned is positioned on that date in a geographical cluster that encompasses the address of the user. The empty parcel container can e.g. be provided as soon as another parcel is taken out of the modular container stack.

To improve the structural integrity of the stack, the fixation mechanism can comprise one or more anti-shear modules, provided on the one or more lateral planes and arranged for constraining a relative lateral movement between stackable parcel containers stacked along the longitudinal direction. The one or more anti-shear module can e.g. comprise connecting elements between individual parcel containers, and/or retainer rings around the outer circumference of one or more adjacently packed parcel containers in a lateral layer, or extending between adjacent lateral layers. Additionally, by staggering connecting seams, e.g. creating an alternating or overlapping pattern, fault lines between adjacently packed and stacked parcel containers can be minimalized, to further improve the structural integrity of the stack.

Each of the one or more anti-shear modules can comprise one or more male connectors extending from a first stackable side of each stackable parcel container, and one or more female connectors extending into a second stackable side of the stackable parcel container opposite the first stackable side, wherein the one or more male and female connectors are arranged for connecting with each other along the longitudinal direction. As a result, male and female connectors of stacked parcel containers can engage with each other in the stack to provide structural integrity by constraining relative lateral movement between parcel containers.

By providing the first mount with male connectors extending toward the stack, and by providing the second mount with female connectors extending into the second mount, for connecting with female and male connectors on the opposing ends of the stack, respectively, the structural integrity of the stack can be even further improved while constraining relative lateral movement between stackable parcel containers.

In some other or further embodiments, the second mount comprises a plate that is mounted to one of the opposing ends of the stack, and a retaining edge extending from the plate around a circumference of the stack and arranged for retaining stackable parcel containers in the one or more lateral planes, wherein the retaining edge has an inner cross section that matches an outer cross section of the stack. In this way, structural integrity of the stack is provided by the plate and retaining edge holding exterior sides of the stack together. The plate and/or retaining edge may additionally be provided with connectors, for connecting with male/female connectors of opposing ends of the stack, to further improve structural integrity.

The fixation mechanism can for example comprise one or more interconnect members that provide a connection between the first and second mount, wherein the one or more interconnect members span along the longitudinal direction between the first and second mount for defining the adjustable distance. For example, one interconnect member may extend centrally through the stack between the first and second mount. Alternatively, or additionally, one or more interconnect members may extend along exterior sides or corners of the stack between the first and second mount. Alternatively, or additionally, one or more interconnect members may be part of a bracket-like fixation mechanism, e.g. extending between the first and second mount at a lateral offset from the stack.

Optionally, the fixation mechanism can comprise a lock-and-release mechanism for locking the connection between the one or more interconnect members and the first and/or second mount, and for releasing the connection. The lock-and-release mechanism can e.g. comprise an (electro-) mechanical lock, or unique tools for operating the lock-and-release mechanism. In this way, it can be prevented that unauthorized individuals are able to dislodge stackable parcel containers from the stack, while the modular container stack can still be modified or serviced by authorized personnel.

In some embodiments, the modular container stack comprises a base for supporting the stack on a ground surface, wherein the first mount is part of the base. The base may comprise a docking mechanism that is movable between a dock position and a release position, wherein the docking mechanism is arranged for docking the base to a ground fixed anchor in the dock position, and for releasing the base therefrom in the release position. A ground fixed anchor can e.g. be provided by an existing structure such as a building, foundation, light pole, high voltage pylon, underground container, etc., or may be provided by a dedicated anchoring arrangement, which may for example be buried in the ground or fastened or cast into other structures.

In some variants, the docking mechanism may be arranged for cooperating with a ground fixed anchor that extends from the ground surface, wherein the docking mechanism comprises: (i) a slot, provided in a bottom side of the base and comprising a short side at a central portion of the base, and opposing long sides extending from the short side beyond a lateral side of the base, for thereby forming a docking port extending from the lateral side towards the central portion and along the ground surface; and (ii) a latch, extendible between the opposing long sides and retractable therefrom, wherein the latch is arranged for closing the docking port in the dock position, and for opening the docking port in the release position.

In the dock position, the ground fixed anchor is locked inside the docking port. The latch may for example be actuated by an actuator, e,g. via a mechanism, that can be controlled by authorized personnel only. In this way, the modular container stack can be positioned, e.g. moved or slid, over the ground fixed anchor and secured thereto in a tamper-proof fashion.

Preferably, each stackable parcel container comprises a wall structure made of a polymer foam material, wherein sides of the stackable parcel container that face an exterior of the stack are reinforced by cover plating. As a result, the weight of the stack can be minimized by the polymer foam material, while the cover plating protects the internal storage space of each stackable parcel container. The cover plating can e.g. be made of a metal such as aluminium or steel, a polymer such as acrylonitrile butadiene styrene (ABS), high-density polyethylene (HDPE) or polycarbonate (PC), and composite or fiber reinforced materials. As such, the cover plating may be both light-weight as well as provide high strength, toughness, and impact resistance.

In some embodiments, each stackable parcel container has a minimum grid size in the lateral plane. In this way, the number of fault lines in the stack is minimized, thereby improving the structural integrity of the stack. Also, having a minimum grid size facilitates solving computational methods, such as a Bin Packing Problem, for providing a solution to stack the modular container stack.

Other aspects of the invention pertain to a method for stacking a modular container stack. The method comprises:
providing one or more stackable parcel containers, each stackable parcel container providing an internal storage space arranged for storing a respective parcel of corresponding dimensions, wherein each stackable parcel container comprises a door for allowing access to the respective internal storage space, and a locking device for locking the door;
forming a stack by adjacently packing, in one or more lateral planes, and stacking, along a longitudinal direction, the one or more stackable parcel containers, wherein the respective door of each stackable parcel container is provided on an exterior side of the stack facing a lateral direction; and
fixating the one or more stackable parcel containers with respect to each other, by a fixation mechanism comprising a first mount and a second mount at an adjustable distance from the first mount, wherein opposing ends of the stack facing the longitudinal direction are mounted between the first and second mount.

In some embodiments, the method further comprises the step of assigning, to each stackable parcel container, an identifier that is coupled to a cluster of geographical locations, and wherein the step of providing one or more stackable parcel containers is performed by selecting stackable parcel containers of which the identifier is coupled to the same cluster of geographical locations. Accordingly, an optimal location can be determined for an unmanned PUDO, to be formed by a modular container stack assembled based on the parcels or other items to be delivered to the addresses in a respective geographic cluster.

In other or further embodiments, the step of forming a stack is performed using a computer programme, wherein the computer programme is configured to minimize the volume of the stack. Accordingly, the transportability of the modular container stack can be improved. As described herein, to stack a modular container stack in the most efficient way, a stacking algorithm e.g. based on the so-called Bin Packing Problem can be used, in a way that minimizes the number of bins used.

### BRIEF DESCRIPTION OF THE DRAWINGS

The invention will be further elucidated in the figures:

FIG. 1 provides an exploded view of an embodiment of a modular container stack;

FIG. 2 illustrates a side view of an embodiment of a stackable parcel container of the modular container stack described herein;

FIG. 3 provides a detailed view of another or further embodiment of a stackable parcel container of the modular container stack described herein;

FIGS. 4A and 4B provide an isometric view of a fixation mechanism of the modular container stack described herein;

FIGS. 5A and 5B illustrate a top view and detailed view, respectively, of another or further embodiment of a fixation mechanism of the modular container stack described herein;

FIGS. 6A-C illustrate an exemplary embodiment of a fixation mechanism of the modular container stack described herein;

FIGS. 7A-C illustrate an exemplary embodiment of a lock-and release-mechanism of the modular container stack described herein;

FIG. 8 represents an embodiment of a method for stacking a modular container stack;

FIG. 9 provides another embodiment of the method described herein;

FIG. 10 illustrates an example of geographical clustering performed by an embodiment of the method described herein.

### DETAILED DESCRIPTION

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

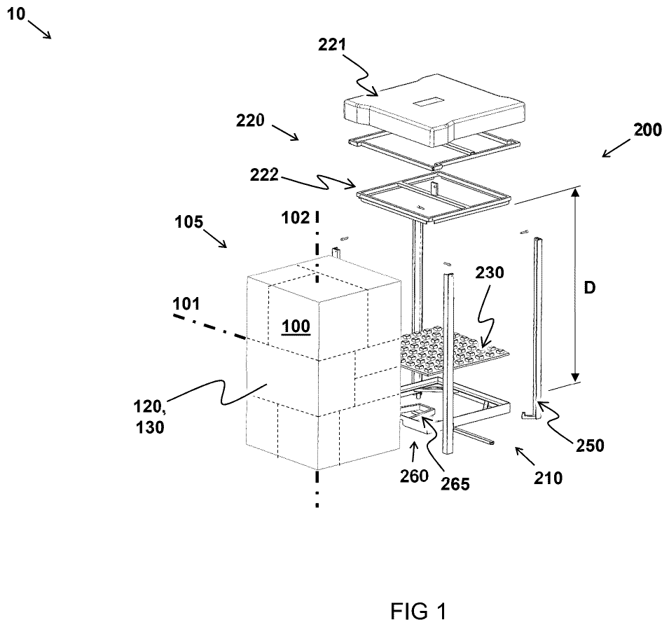

FIG. 1 represents an embodiment of a modular container stack 100. The modular container stack 10 comprises one or more stackable parcel containers 100 and a fixation mechanism 200, arranged for fixating the one or more stackable parcel containers 100 with respect to each other.

The one or more stackable parcel containers 100 are adjacently packed in one or more lateral planes 101 and stacked along a longitudinal direction 102, e.g. defining a height dimension, for forming a stack 105. Each of the one or more lateral planes 101 does not necessarily extend along the full width and depth dimensions of the stack, but may extend along these dimensions only partially, thus forming staggering connecting seams or fault lines between adjacently packed and stacked parcel containers 100, e.g. creating an alternating or overlapping pattern.

Preferably, each stackable parcel container 100 has a minimum grid size in the lateral plane 101, e.g. a minimum width and depth dimension. The minimum grid size may also apply to the height dimension of the stack.

The absolute orientation of the lateral planes 101 and the longitudinal direction 102, e.g. with respect to a ground surface, is irrelevant for the present disclosure. For example, the one or more lateral planes 101 can be horizontal, and the height direction 102 can be vertical, e.g. substantially perpendicular to a ground surface. Alternatively, the one or more lateral planes 101 can be vertical, and the longitudinal direction 102 can be horizontal, e.g. substantially parallel to a ground surface. Each stackable parcel container 100 provides an internal storage space arranged for storing a respective parcel of corresponding dimensions. For example, the size of the storage space may be adapted to the size of the parcel, or vice versa, so that the combination of parcel and storage space is as compact as possible. The walls of the internal storage space are preferably made of a foam polymer material, such as expanded polypropylene (EPP), to protect the parcel inside while providing structural integrity. As such, each stackable parcel container 100 can be used as a package for transport, e.g. replacing conventional packaging means such as cardboard boxes, e.g. filled with air bags or foam nuggets. This may enable “packaging-free” delivery and storage of parcels. Instead of parcels, any other item can be stored and delivered.

Each stackable parcel container 100 comprises a door 120 on an exterior side of the stack facing a lateral direction for allowing access to the respective internal storage space. A locking device 130 is provided on each stackable parcel container 100, for locking the door 120.

The fixation mechanism 200 comprises a first mount 210 and a second mount 220 at an adjustable distance D from the first mount 210. Opposing ends of the stack facing the longitudinal direction 102 are mounted between the first and second mount 210, 220. In this way, the one or more stackable parcel containers 100 are fixated, e.g. clamped or form-closed, along the longitudinal direction 102 between the first and second mount 210, 220. The thus formed fixation, e.g. clamping or form-closing, also ensures that the one or more stackable parcel containers 100 are fixated along the one or more lateral planes 101.

For example, the fixation mechanism 200 can comprise one or more anti-shear modules 230, provided on the one or more lateral planes 101 and arranged for constraining a relative lateral movement between stackable parcel containers 100 stacked along the longitudinal direction 102. Accordingly, the structural integrity of the stack can be improved by constraining lateral relative movement between stacked parcel containers.

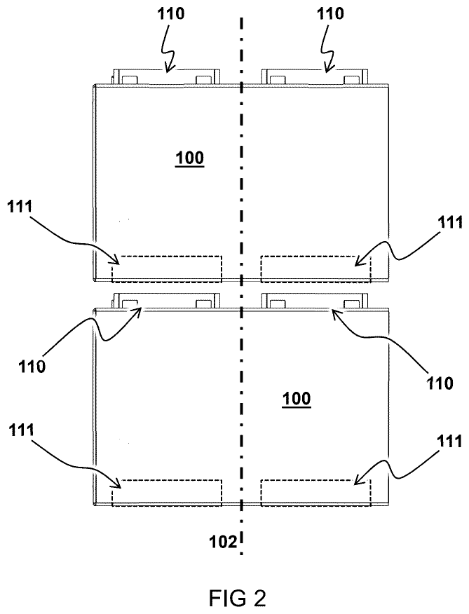

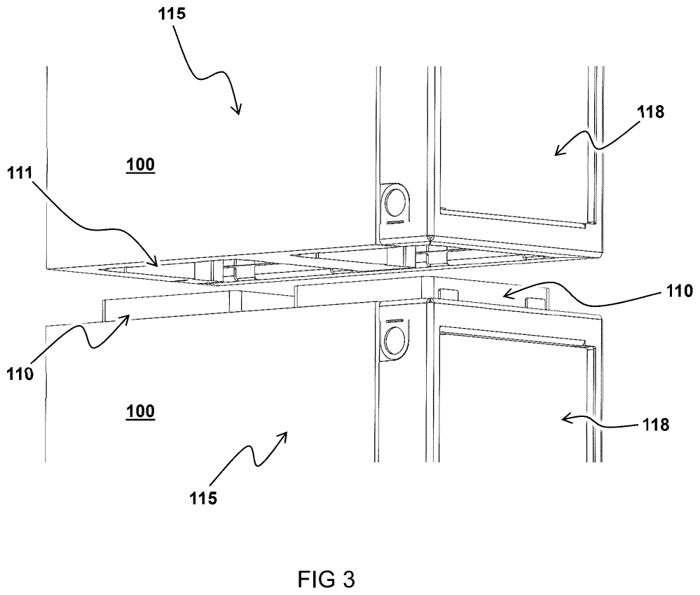

In FIGS. 2 and 3, an exemplary embodiment of such an anti-shear module 230 is illustrated, comprising two male connectors 110 extending from a first stackable side of each stackable parcel container 100, and an equal number of female connectors 111 extending into a second stackable side of the stackable parcel container 100 opposite the first stackable side. Alternatively, each stackable parcel container 100 may comprise any other number of anti-shear modules 230 or connectors, e.g. one male and female connector 110, 111, or more than two male and female connectors 110, 111. The one or more male and female connectors 110, 111 are arranged for connecting with each other along the longitudinal direction 102, to form a stack. Male connectors 110 of a stackable parcel container 100 may connect with female connectors 111 of more than one stackable parcel container 100, and vice versa, to form staggering connecting seams or fault lines between adjacently packed and stacked parcel containers 100, e.g. creating an alternating or overlapping pattern.

Anti-shear modules 230 can also be formed by other types of connections between stackable parcel containers 100, such as mechanical connections e.g. involving engagement of pins, hooks, edges, slots, grooves or ribs to prevent lateral movement between parcel containers, magnetic connections, friction connections e.g. by using anti-slip materials on contact surfaces, and snap-fit, press-fit, or form-closing connections. As another example, anti-shear modules 230 can be formed by retainer rings or bars extending around the circumference of the stack, to retain one or more stackable parcel containers 100 in the one or more lateral planes.

FIG. 3 illustrates that each stackable parcel container 100 may comprise a wall structure 115 made of a polymer foam material, such as expanded polypropylene (EPP), to minimize the weight of the modular container stack while providing relatively good structural strength as well as impact resistance. Sides of the stackable parcel container 100 that face an exterior of the stack may be reinforced by cover plating 118, e.g. made of a metal or fiber reinforced composite material. Preferably the cover plating 118 is relatively thin walled compared to the wall thickness of the wall structure 115 of the stackable parcel container. By having exterior sides of the stack reinforced by cover plating 118, impact resistance can further be improved while minimizing the total weight of the stack, thereby facilitating transportability.

As earlier illustrated in FIG. 1, the first mount 210 may be provided with one or more male connectors extending toward the stack, and the second mount 220 may be provided with one or more female connectors extending into the second mount, for connecting with female and male connectors on the opposing ends of the stack, respectively.

FIG. 1 also illustrates a fixation mechanism 200 that can comprise one or more interconnect members 250, such as plates, profiles, cables, rods, or beams, that provide a connection between the first and second mount 210, 220. For example, the fixation mechanism 200 can comprise four interconnect members 250, each of which extends along an exterior side of the stack, e.g. along exterior sides or corners of the stack. Alternatively, or additionally, the fixation mechanism 200 can comprise one or more interconnect members 250 that extend through an interior of the stack, e.g. centrally, or adjacent to interior facing sides of parcel containers 100. The one or more interconnect members 250 may span along the longitudinal direction 102 between the first and second mount 210, 220 for defining the adjustable distance D.

In some embodiments, e.g. in case it is desired to stack the one or more stackable parcel containers 100 along a longitudinal direction 102 perpendicular to the ground surface, e.g. as illustrated in FIG. 1, the fixation mechanism 200 can comprise a base 260 for supporting the stack on the ground surface. Preferably, the first mount 210 is part of the base 260. The base 260 may comprise a docking mechanism 265 that is movable between a dock position and a release position, wherein the docking mechanism 265 is arranged for docking the base 260 to a ground fixed anchor in the dock position, and for releasing the base therefrom in the release position. The docking mechanism 265 can e.g. be arranged for cooperating with a ground fixed anchor that extends from the ground surface. To achieve this, the docking mechanism may comprise a slot provided in a bottom side of the base and comprising a short side at a central portion of the base, and opposing long sides extending from the short side beyond a lateral side of the base, for thereby forming a docking port extending from the lateral side towards the central portion and along the ground surface.

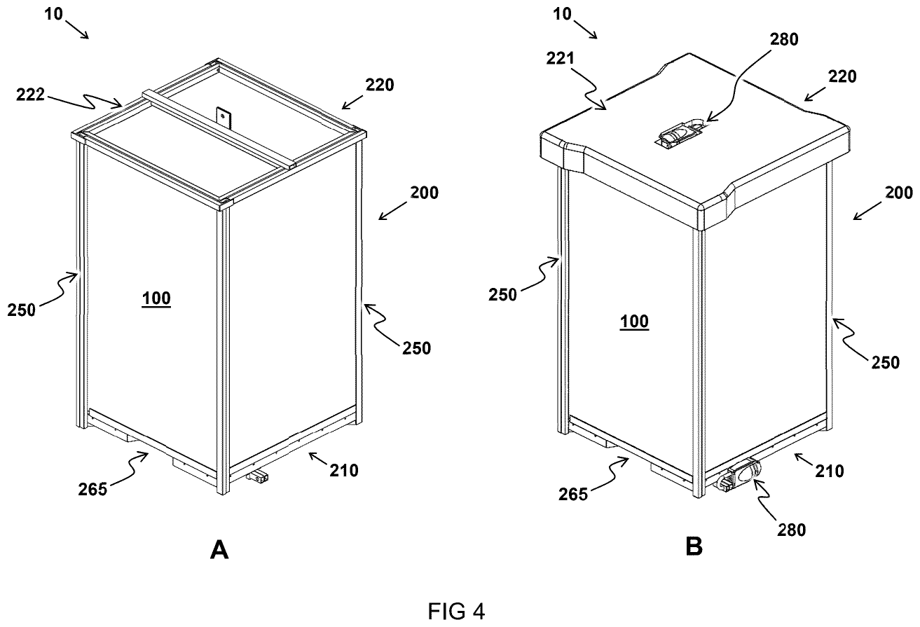

To lock the ground fixed anchor inside the docking port in the dock position, the docking mechanism 265 may further comprise a latch, extendible between the opposing long sides and retractable therefrom, wherein the latch is arranged for closing the docking port in the dock position, and for opening the docking port in the release position. The docking mechanism 265 may further comprise a locking device 280, e.g. to lock the latch in the dock position, and to release the latch therefrom. Such a locking device 280 can e.g. be provided at an edge of the first mount 210, as illustrated in FIGS. 4A and B.

As shown in FIGS. 4A and B, the fixation mechanism 200 may further comprise a lock-and-release mechanism 280, e.g. comprising one or more mechanical or electromechanical additional lock devices 280, such as an electronic padlock, for locking the connection between the one or more interconnect members 250 and the first and/or second mount 210, 220, and for releasing the connection. The additional lock devices 280 can e.g. be provided at the first and/or second mount 210, 220. For example, an additional lock device 280 can be provided at a substantially central location in the second mount 220, e.g. near a cross beam fixating a retaining edge 222 mounted around the stack of parcel containers 100 and engaging with the interconnect members, to lock and release the connection between the retaining edge, the one or more interconnect members 250, and/or the second mount 220. Alternatively, or additionally, an additional lock device 280 can be provided at an edge of the first mount 210, which may e.g. be arranged for engaging with to the interconnect members, to lock and release the connection between the first mount 210 and the interconnect members 250.

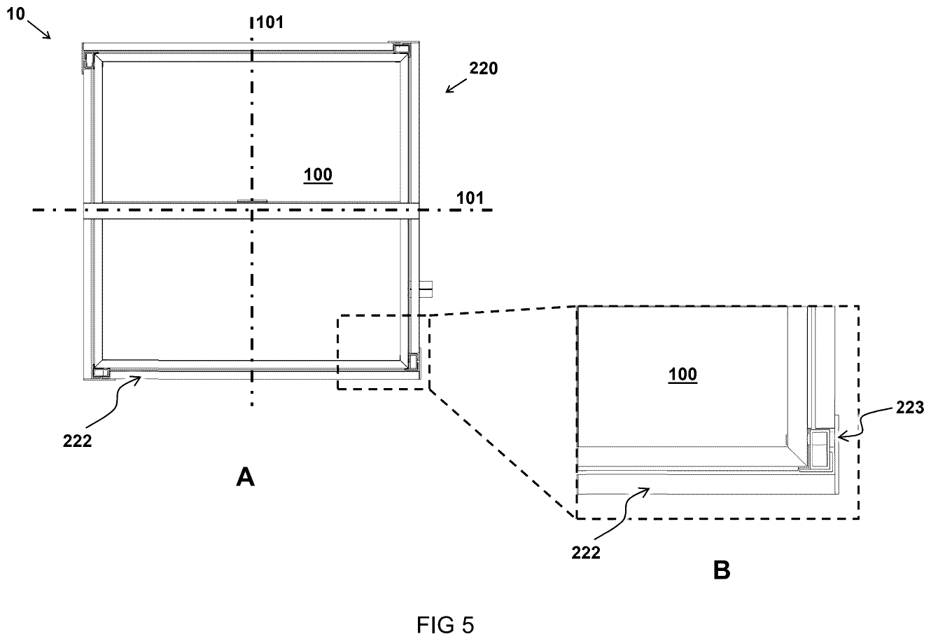

To further improve the structural integrity of the stack, the second mount can comprise a plate 221 that is mounted to one of the opposing ends of the stack. As shown in FIG. 5A, the second mount 220 may further have a retaining edge 222 extending from the plate around a circumference of the stack, and have an inner cross section that matches an outer cross section of the stack. In this way, the second mount 220 is arranged for retaining stackable parcel containers 100 in the one or more lateral planes 101. FIG. 5B provides a detailed view of the retaining edge 222, illustrating that the retaining edge 222 may comprise an engagement mechanism 223 comprising one or more protrusions, such as pins or hooks, arranged for extending from the retaining edge 222 into one or more stackable parcel containers 100, e.g. at the edges of the stack, to secure the relative lateral positions of the one or more stackable parcel containers 100, with respect to each other and/or with respect to the retaining edge 222.

Alternatively, or additionally, the modular container stack 10 can comprise one or more additional retainer rings, provided on the one or more lateral planes 101 and extending around a circumference of the stack and/or between stacked parcel containers. Accordingly, the additional retainer rings are arranged for additionally retaining, or constraining, stackable parcel containers 100 in the one or more lateral planes 101.

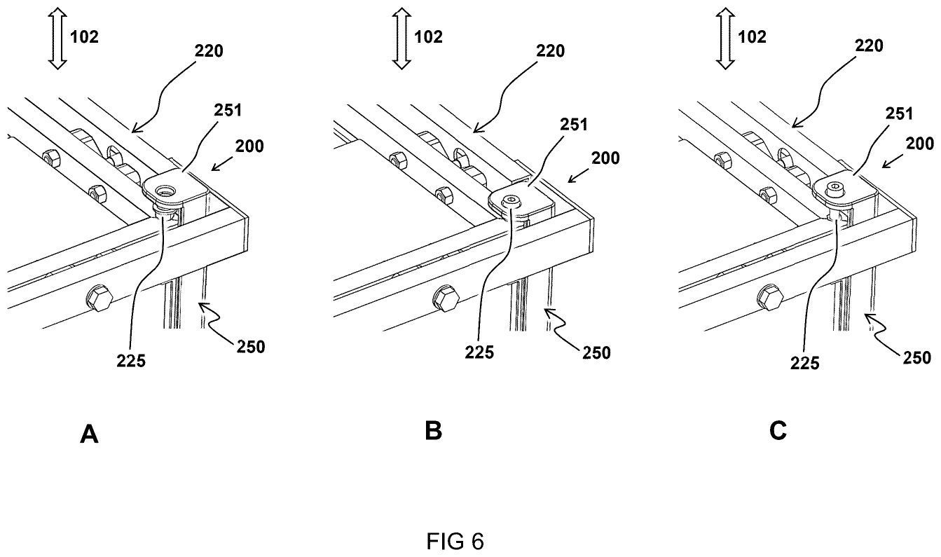

FIG. 6A-C illustrate the operation of an exemplary embodiment of the fixation mechanism 200. As described earlier, the fixation mechanism 200 may comprise one or more interconnect members 250, e.g. provided along exterior sides or corners of the stack, that span along the longitudinal direction 102 between the first and second mount for adjusting the distance therebetween. In this particular instance, the interconnect member 250 comprises a corner profile which, in mounted position, extends around a corner of the stack. In FIGS. 6A-C, only second mount 22 is illustrated. In this exemplary embodiment, a set screw 225 is screwed into a threaded hole in the second mount 220. The set screw 225 may have a head provided with a flange. The interconnect member 250 may comprise at its axial end a cover plate 251 with a hole which in mounted position of the interconnect member 250 is coaxially aligned with the head of the set screw 225, as illustrated in FIG. 6A. The diameter of the head of the set screw is smaller than the diameter of the hole, while the diameter of the flange is larger. Hence, by unscrewing the set screw 225 from the second mount 220, the flange can be brought in contact with a bottom surface of the cover plate 251, so that the head of the set screw 225 protrudes through the hole in the cover plate 251, see FIG. 6B. By unscrewing the set screw 225 further, the flange applies a tension on the interconnect member causing the first mount 210 to be pushed towards the first mount in the longitudinal direction 102, thereby applying a clamping force on the stack of containers, e.g. as shown in FIG. 6C. Accordingly, the first and second mount clampingly fixate any stackable parcel containers arranged between the first and second mount 210, 220 onto to each other in the longitudinal direction 102, thereby fixating the parcel containers in the lateral direction too.

The opposing first mount can be provided with a similar set screw fixation mechanism for clamping the stack of parcel containers in the longitudinal direction 102. Alternatively, only one of the first and second mount is provided with one or more set screws, and the one or more interconnect members are fixedly attachable to the other mount. Instead of a set screw type of fixation mechanism, the first and/or second mount can be provided with any other type of fixation or tensioning mechanism, e.g. for generating a tension in the interconnect member 250 in order to clamp the stackable parcel containers in the longitudinal direction.

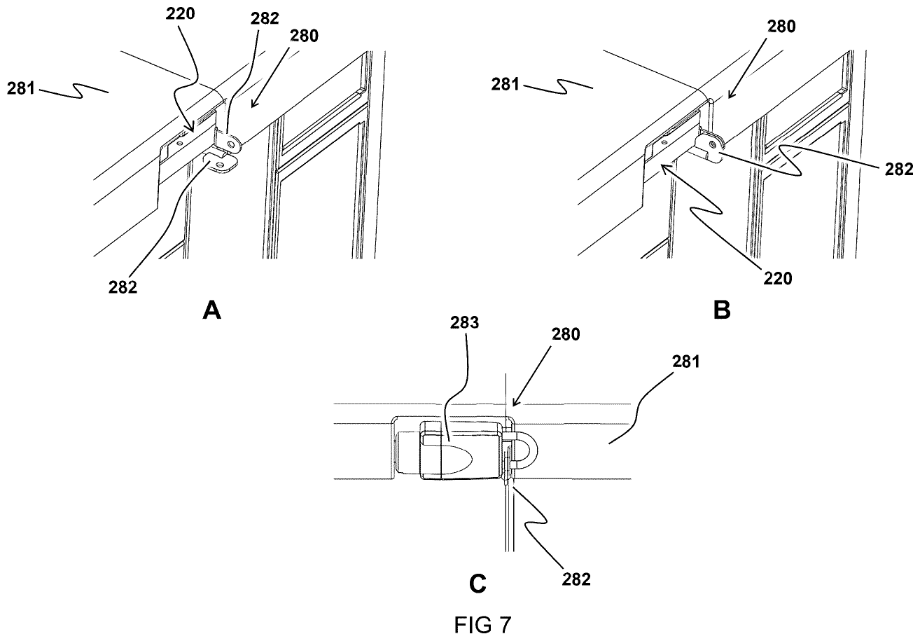

FIGS. 7A-C illustrates an exemplary embodiment of a lock-and-release mechanism 280 for locking the connection between the one or more interconnect members 250 and the first and/or second mount 210, 220, and for releasing the connection. The lock-and-release mechanism 280 can be combined with a fixation mechanism 200 as described herein, e.g. as illustrated in FIGS. 6A-C. For example, after fixating the stack by applying a clamping force on the stackable parcel containers between the first and second mount, a cover element 281 may be locked onto the first and/or second mount in order to prevent unauthorized access to the fixation mechanism 200. Accordingly, individual stackable parcel containers can only be taken out of the stack after releasing the lock-and release mechanism, e.g. releasing the cover element 281 from the first and/or second mount. As illustrated in FIGS. 7A and B, the lock-and-release mechanism 280 may comprise one or more pairs of lock tabs 282. Each pair of lock tabs 282 may comprise a first lock tab provided on the first and/or second mount 220, and a second lock tab 282 provided on the cover element 281. The first and second lock tab 282 can be aligned with respect to each other in mounted position of the cover element on the mount 220. Each of the first and second lock tabs 282 may comprise an eye, the eyes of corresponding lock tabs 282 aligned with each other in the lock position. A lock device 283, such as a (electronic) pad lock, can be passed through the eyes to secure the lock tabs in the lock position, see FIG. 7C. Accordingly, the cover element 281 covers the fixation mechanism.

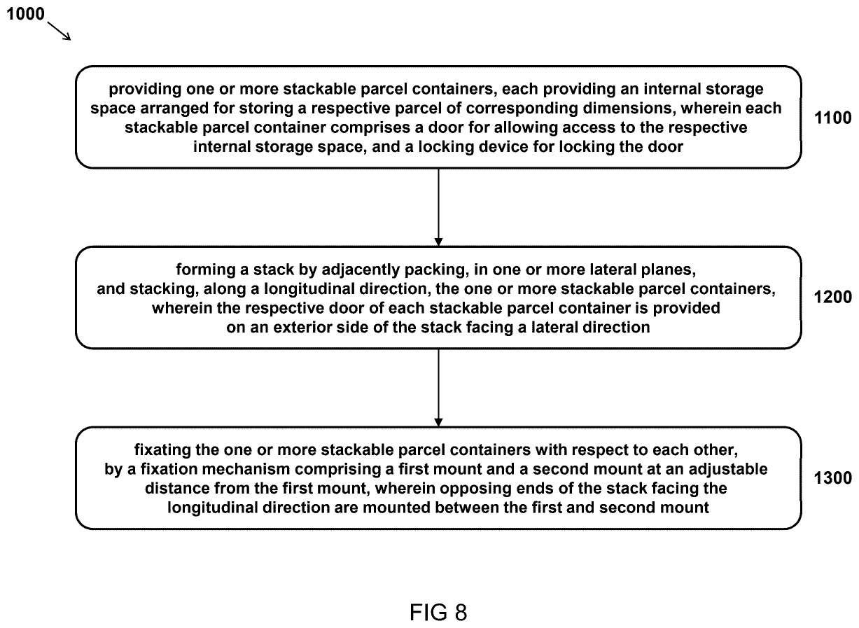

FIG. 8 represents an embodiment of a method 1000 for stacking a modular container stack. The method 1000 comprises step 1100 of providing one or more stackable parcel containers, each stackable parcel container providing an internal storage space arranged for storing a respective object of corresponding dimensions, wherein each stackable container comprises a door for allowing access to the respective internal storage space, and a locking device for locking the door.

The method 1000 further comprises a step 1200 of forming a stack by adjacently packing, in one or more lateral planes, and stacking, along a longitudinal direction, e.g. height direction, the one or more stackable parcel containers, wherein the respective door of each stackable parcel container is provided on an exterior side of the stack facing a lateral direction. Step 1200 can e.g. be performed using a computer programme, wherein the computer programme is configured to minimize the volume of the stack. Additionally, step 1200 of forming a stack may include one or more of (i) ensuring that reinforced sides of the one or more stackable parcel containers are exposed on the exterior of the stack; (ii) calculating various layouts of the stack in which doors are exposed on one, two, three or four sides of the stack; and (iii) completing the stack by stacking one or more empty parcel containers, wherein the one or more empty parcel containers are available for parcels to be returned to sender.

The method 1000 further comprises a step 1300 of fixating the one or more stackable containers with respect to each other, by a fixation mechanism comprising a first mount and a second mount at an adjustable distance from the first mount, wherein opposing ends of the stack facing the longitudinal direction are mounted between the first and second mount.

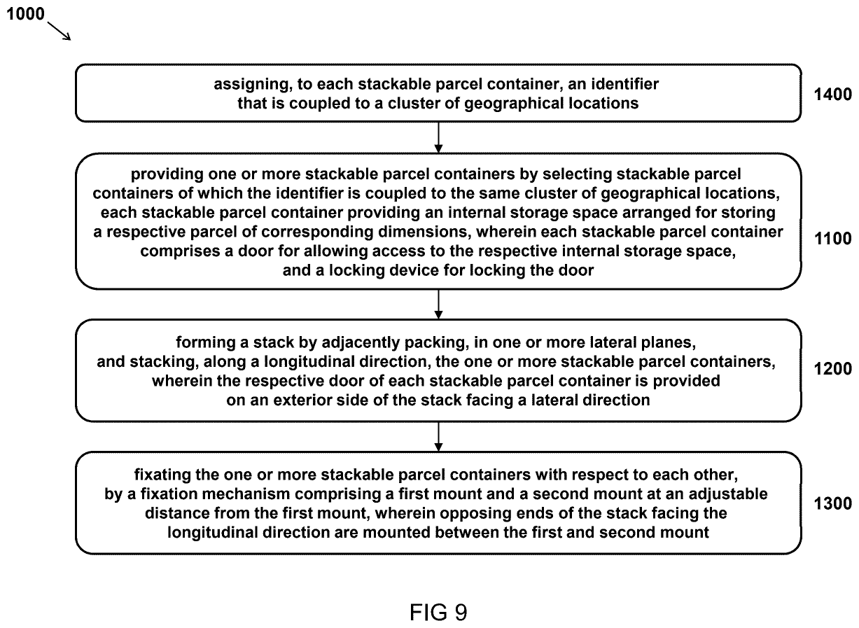

As illustrated in FIG. 9, the method 1000 may further comprise the step 1400 of assigning, to each stackable parcel container, an identifier that is coupled to a cluster of geographical locations, and wherein step 1100 of providing one or more stackable parcel containers is performed by selecting stackable parcel containers of which the identifier is coupled to the same cluster of geographical locations.

### Stacking Algorithm

In order to stack a modular container stack in the most efficient way, good results can be achieved by using a stacking algorithm based on the so-called Bin Packing Problem. The Bin Packing Problem may be defined as an optimization problem, in which items of different sizes must be packed into a finite number of bins or containers, each of a fixed given capacity, in a way that minimizes the number of bins used. The Bin Packing Problem, is known to an ‘NP-Hard’ (Nondeterministic Polynomial time Hard) problem and can be regarded as an optimization problem. For example, the present stacking algorithm can comprise an offline/multiplicative approximation using a modified first-fit-decreasing (FFD) bin packing algorithm, and may involve the following steps:
receiving, for each PUDO location, data corresponding to stackable parcel containers of different volumes to be delivered to a respective PUDO location;
ordering the stackable parcel containers by descending volume;
performing, for each stackable parcel container, the modified FFD bin packing algorithm, by executing the following steps:
   a) if the stackable parcel container is empty and if the parcel is smaller than the stackable parcel container, the parcel is stored in the stackable parcel container, and the stackable parcel container is placed in the stack at an initial location-such as a back left corner with a 270 or 0 degree rotation.
   b) for subsequent stackable parcel containers and respective parcels stored therein:
      i. the subsequent stackable parcel container is tested to fit around existing stackable parcel containers in the stack with rotations of 270, 0, 90 and 180 degrees.
      ii. if the subsequent stackable parcel container doesn't intersect with existing stackable parcel containers in the stack and, if the subsequent stackable parcel container has its door facing a lateral side of the stack and, if the subsequent stackable parcel container's cover plated side faces a lateral side of the stack (or all sides except the door are hidden) then the subsequent stackable parcel container is fitted into the stack.
   c) after all stackable parcel containers are tested and if parts of the stack are not completely filled, one or more empty stackable parcel containers (without respective parcels stored therein), or dummy volumes (e.g. blocks without an internal storage space), may be added to complete the stack.

The above-mentioned algorithm can also be employed to calculate various layouts of the stack for solving the problem of how to form a stack in which doors are exposed on one, two, three or four sides of the stack.

### Geospatial Clustering

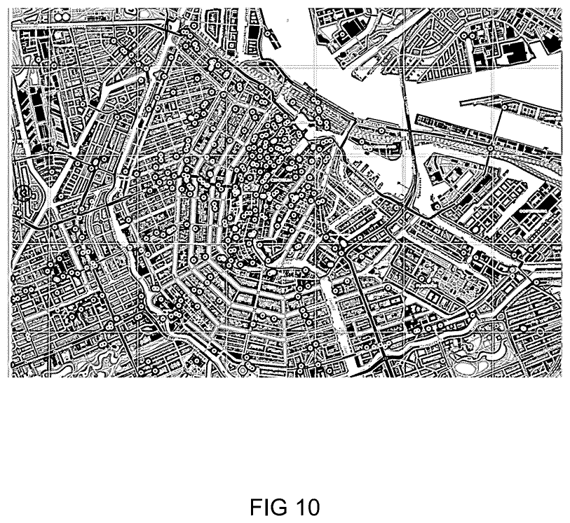

In order to calculate the most efficient drop-off location for each modular storage container, a geospatial clustering algorithm can be applied, e.g. as illustrated in FIG. 10. As a result, parcels can be delivered to a location within a range of 0-500 meters from intended recipient addresses, preferably within a range of 0-300 meters, more preferably within a range of 0-200 meters, e.g. within walking distance.

For example, on a particular day, all parcels that need to be delivered from a certain city hub may be consolidated and clustered based on the geographical coordinates of their respective parcel destinations. Roughly, it is almost like drawing circles of 200 meter diameter on a map and organizing the parcel orders in those circles.

As a clustering algorithm, “agglomerative clustering” can for example be used with a maximum distance between destinations within the cluster, e.g. 200 meter. Accordingly, the resulting geographical clusters may be approximately 200 m wide.

The clustering algorithm may need to be supplied with a distance matrix, in which the interdistance between each destination is provided to create the clusters.

An example of a distance matrix is provided below:

| | Address 1: | | Address 2: | | Address 3: | |
|---|---|---|---|---|---|---|
| | 2 Parcel Order by | | 1 Parcel Order by | | 3 Parcel Order by | |
| | Jim | | Anouk | | Jon | |
| Address 1: | 0 | meter | 1500 | meter | 300 | meter |
| 2 Parcel Order by Jim | | | | | | |
| Address 2: | 1500 | meter | 0 | meter | 1000 | meter |
| 1 Parcel Order by | | | | | | |
| Anouk | | | | | | |
| Address 3: | 300 | meter | 1000 | meter | 0 | meter |
| 3 Parcel Order by Jon | | | | | | |

Looking at the data in the exemplary distance matrix above, most probably Jon and Jim's parcels would end up in the same cluster and/or modular parcel container, since the interdistance of 300 meter between Jon and Jim's address may be within a geographical cluster. However, Anouk's would end up in a separate one, since the interdistance of 1000 meter or 1500 meter between Jon's and Jim's address, respectively, would probably place Anouk's address in a separate geographical cluster.

Interdistances can be derived from various methods and/or mode of transports, for example:
Haversine distance, also known as the crow flies distance. It is calculated with a formula taking the Earth's curvature into consideration. There is no external data required to calculate it and its calculation speed is within nanoseconds.
Driving distance, e.g. going from A to B using roads complying with motor vehicle laws and regulations. It may require external data.
Cycling distance, e.g. going from A to B using bicycle paths, which may be more forgiving, or provide more versatile routing options, compared to roads. It may require external data.
Walking distance, e.g. going from A to B by foot. It may require external data. Walking distance, combined with changes in terrain elevation may be taken into account to calculate the effective effort to walk from A to B.

### Query Count Optimization

Though clustering can be performed as a standalone process, it may still depend on external data. The querying of distance matrices can be a costly process, both timewise as well as financially.

For example, there may be 100 addresses that need to be geographically clustered. As a result, a 100×100 matrix composed of 100,000 distance data entries needs to be created. For 1000 orders, and respective addresses, the number of distance data entries becomes 1,000,000. Hence, scaling the number of addresses exponentially increases the process cost.

Known cloud and/or map providers with distance matrix APIs can be used to query for such large matrix scenarios. However, these API's are limited as they may only allow to query data if it results with 100 or fewer data points. For example, it may be possible to query 1 source against 100 destinations or 10 sources against 10 destinations. This means that, for 30 addresses, multiple queries may need to be performed:

| | Addresses from 1 to | Addresses from 11 | Addresses from 21 |
|---|---|---|---|
| | 10 | to 20 | to 30 |
| Addresses from 1 to | Query 1 | Query 2 | Query 3 |
| 10 | | | |
| Addresses from 11 | Query 4 | Query 5 | Query 6 |
| to 20 | | | |
| Addresses from 21 | Query 7 | Query 8 | Query 9 |
| to 30 | | | |

Another limitation of known APIs, is that they may return a matrix which provides all combinations of sources to destinations and destinations to sources.

For driving and cycling it makes sense to get data from source to destination and also from destination to source because the way forward can be completely different from the way back as there might be one-way streets, constructions etc—so, the data is asymmetric. However, walking distance is predominantly a symmetric process, as it is almost always possible to walk back the path you walked from A to B (especially in city setting for slipper distance). Accordingly, for the data points for which the distance from A to B is already known, it may not be required to determine the distance from B to A.

Following these observations and assumptions, for the example above which have 30 addresses resulting in 9 queries, at least 3 queries will be redundant.
Query 2 is the same as Query 4.
Query 3 is the same as Query 7.
Query 6 is the same as Query 8.

Hence, queries 4, 7 and 8 are obsolete because they are already covered by queries 2, 3 and 6. The diagonal is a necessary evil. Half of the diagonal queries are also symmetric but it can be an overkill (yet possible) to optimize them.

### Multiple Clustering Layers

A multiple clustering layer optimization strategy can be applied, based on the fact that “there is no shorter distance than crow flies distance (Harversine distance) between two points.” It is considered a low-cost calculation as it is based on a single formula.

If the distance between address A and address B is more than 200 meters in Haversine distance there is definitely no path to walk from A to B in less than 200 meters. This logic can also be applied to groups of addresses. Addresses can be grouped or clustered in such a way that the Haversine distance between the groups or clusters is equal to or less than 200 meters. As a result, multiple single distance matrices can be created with a size that is significantly smaller than the size of a city-wide matrix.

This is for example achievable by first using a data clustering algorithm, such as DBSCAN, e.g. with Haversine distance, to create clusters that are 200-500 m apart. Alternatively, other clusters with other interdistances can be created, e.g. depending on the population or geographical features of an area, such as bodies of water and natural vegetation. After that for each cluster, agglomerative clustering can be performed with a maximum travel or walking distance between addresses within the cluster.

It is thus believed that the operation and construction of the present invention will be apparent from the foregoing description and drawings appended thereto. For the purpose of clarity and a concise description features are described herein as part of the same or separate embodiments, however, it will be appreciated that the scope of the invention may include embodiments having combinations of all or some of the features described.

The invention applies not only to parcel delivery applications where the modular container stack is used for storing parcels or other items and objects, but also to other technical, industrial or agricultural applications where a modular container stack is used. It will be clear to the skilled person that the invention is not limited to any embodiment herein described and that modifications are possible which may be considered within the scope of the appended claims. Also, kinematic inversions are considered inherently disclosed and can be within the scope of the invention. In the claims, any reference signs shall not be construed as limiting the claim.

The terms ‘comprising’ and ‘including’ when used in this description or the appended claims should not be construed in an exclusive or exhaustive sense but rather in an inclusive sense. Thus, expression as ‘including’ or ‘comprising’ as used herein does not exclude the presence of other elements, additional structure or additional acts or steps in addition to those listed. Furthermore, the words ‘a’ and ‘an’ shall not be construed as limited to ‘only one’, but instead are used to mean ‘at least one’, and do not exclude a plurality. Features that are not specifically or explicitly described or claimed may additionally be included in the structure of the invention without departing from its scope.

Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. To the extent that structure, material, or acts are considered to be essential they are inexpressively indicated as such. Additions, deletions, and modifications within the purview of the skilled person may generally be made without departing from the scope of the invention, as determined by the claims.

What is claimed is:

1. A modular container stack comprising:
at least two stackable parcel containers, wherein the at least two stackable parcel containers are adjacently packed in one or more lateral planes and adjacently stacked along a longitudinal direction for forming a stack, each stackable parcel container providing an internal storage space arranged for storing a respective parcel, wherein each stackable parcel container comprises a door on an exterior side of the stack facing a lateral direction for allowing access to the respective internal storage space, and a locking device for locking the door; and
a fixation mechanism, arranged for fixating the at least two stackable parcel containers with respect to each other;
wherein the fixation mechanism comprises a first mount and a second mount at an adjustable distance from the first mount, and wherein opposing ends of the stack facing the longitudinal direction are mounted between the first and second mount, wherein the stack of the at least two stackable parcel containers is clamped between the first and second mount, wherein said clamping of the stack of the at least two stackable parcel containers between the first and second mount fixates the at least two stackable parcel containers along the longitudinal direction and along the one or more lateral planes;
wherein some of the one or more lateral planes does not extend along the full width and depth dimensions of the stack, but extend along these dimensions only partially, thus forming staggering connecting seams or fault lines between adjacently packed and stacked parcel containers, creating an alternating or overlapping pattern.

2. Modular container stack according to claim 1, wherein the fixation mechanism comprises one or more anti-shear modules, provided on the one or more lateral planes and arranged for constraining a relative lateral movement between stackable parcel containers stacked along the longitudinal direction.

3. Modular container stack according to claim 2, wherein the one or more anti-shear modules comprise one or more male connectors extending from a first stackable side of each stackable parcel container, and one or more female connectors extending into a second stackable side of the stackable parcel container opposite the first stackable side, wherein the one or more male and female connectors are arranged for connecting with each other along the longitudinal direction.

4. Modular container stack according to claim 3, wherein the first mount is provided with one or more male connectors extending toward the stack, and wherein the second mount is provided with one or more female connectors extending into the second mount, for connecting with female and male connectors on the opposing ends of the stack, respectively.

5. Modular container stack according to claim 1, wherein the second mount comprises a plate that is mounted to one of the opposing ends of the stack, and a retaining edge extending from the plate around a circumference of the stack and arranged for retaining stackable parcel containers in the one or more lateral planes, wherein the retaining edge has an inner cross section that matches an outer cross section of the stack.

6. Modular container stack according to claim 1, wherein the fixation mechanism comprises one or more interconnect members that provide a connection between the first and second mount, wherein the one or more interconnect members span along the longitudinal direction between the first and second mount for defining the adjustable distance.

7. Modular container stack according to claim 6, wherein the fixation mechanism comprises a lock-and-release mechanism for locking the connection between the one or more interconnect members and the first and/or second mount, and for releasing the connection.

8. Modular container stack according to claim 1, wherein the fixation mechanism comprises a base for supporting the stack on a ground surface, and wherein the first mount is part of the base.

9. Modular container stack according to claim 8, wherein the base comprises a docking mechanism that is movable between a dock position and a release position, wherein the docking mechanism is arranged for docking the base to a ground fixed anchor in the dock position, and for releasing the base therefrom in the release position.

10. Modular container stack according to claim 9, wherein the docking mechanism is arranged for cooperating with a ground fixed anchor that extends from the ground surface, wherein the docking mechanism comprises:
a slot, provided in a bottom side of the base and comprising a short side at a central portion of the base, and opposing long sides extending from the short side beyond a lateral side of the base, for thereby forming a docking port extending from the lateral side towards the central portion and along the ground surface; and
a latch, extendible between the opposing long sides and retractable therefrom, wherein the latch is arranged for closing the docking port in the dock position, and for opening the docking port in the release position;
wherein, in the dock position, the ground fixed anchor is locked inside the docking port.

11. Modular container stack according to claim 1, wherein each stackable container comprises a wall structure made of a polymer foam material, and wherein sides of the stackable container that face an exterior of the stack are reinforced by metal covers.

12. Modular container stack according to claim 1, wherein at least some of the at least two stackable parcel containers differ in height and or grid size in the lateral plane.

13. Method for stacking a modular container stack, the method comprising:
providing at least two stackable parcel containers, each stackable parcel container providing an internal storage space arranged for storing a respective parcel of corresponding dimensions, wherein each stackable parcel container comprises a door for allowing access to the respective internal storage space, and a locking device for locking the door;
forming a stack by adjacently packing, in one or more lateral planes, and stacking, along a longitudinal direction, the at least two stackable parcel containers, wherein the respective door of each stackable parcel container is provided on an exterior side of the stack facing a lateral direction; and
fixating the at least two stackable parcel containers with respect to each other, by a fixation mechanism comprising a first mount and a second mount at an adjustable distance from the first mount, wherein opposing ends of the stack facing the longitudinal direction are mounted between the first and second mount, wherein the stack of the at least two stackable parcel containers is clamped between the first and second mount, wherein said clamping of the stack of the at least two stackable parcel containers between the first and second mount fixates the at least two stackable parcel containers along the longitudinal direction and along the one or more lateral planes;
wherein some of the one or more lateral planes does not extend along the full width and depth dimensions of the stack, but extend along these dimensions only partially, thus forming staggering connecting seams or fault lines between adjacently packed and stacked parcel containers, creating an alternating or overlapping pattern.

14. Method according to claim 13, further comprising the step of assigning, to each stackable container, an identifier that is coupled to a cluster of geographical locations, and wherein the step of providing at least two stackable containers is performed by selecting stackable containers of which the identifier is coupled to the same cluster of geographical locations.

15. Method according to claim 13, wherein the step of forming a stack is performed using a computer programme, wherein the computer programme is configured to minimize the volume of the stack.
